(19) United States
(12) Patent Application Publication
(10) Pub. No.: US 2018/0254450 A1
(43) Pub. Date: Sep. 6, 2018

(54) NONAQUEOUS ELECTROLYTE SECONDARY BATTERY SEPARATOR

(71) Applicant: Sumitomo Chemical Company, Limited, Tokyo (JP)

(72) Inventor: Yuichiro AZUMA, Niihama-shi (JP)

(21) Appl. No.: 15/910,077

(22) Filed: Mar. 2, 2018

(30) Foreign Application Priority Data
Mar. 3, 2017 (JP) 2017-041092

(51) Int. Cl. H01M 2/16; H01M 2/14

(52) U.S. Cl. CPC H01M 2/1653; H01M 10/0525; H01M 2/145

(57) ABSTRACT

The present invention provides a nonaqueous electrolyte secondary battery separator having a small difference in air permeability before and after the application of pressure. The nonaqueous electrolyte secondary battery separator includes a polyolefin porous film, the polyolefin porous film being such that an average of a crease resistance per weight per unit area in the TD and a crease resistance per weight per unit area in the MD is not less than 5.0% and that a difference between the crease resistance per weight per unit area in the TD and the crease resistance per weight per unit area in the MD is not more than 3.5%.

This Nonprovisional application claims priority under 35 U.S.C. § 119 on Patent Application No. 2017-041092 filed in Japan on Mar. 3, 2017, the entire contents of which is hereby incorporated by reference.

### TECHNICAL FIELD

The present invention relates to (i) a separator for a nonaqueous electrolyte secondary battery (hereinafter referred to as a “nonaqueous electrolyte secondary battery separator”), (ii) a laminated separator for a nonaqueous electrolyte secondary battery (hereinafter referred to as a “nonaqueous electrolyte secondary battery laminated separator”), (iii) a member for a nonaqueous electrolyte secondary battery (hereinafter referred to as a “nonaqueous electrolyte secondary battery member”), and (iv) a nonaqueous electrolyte secondary battery.

### BACKGROUND ART

Nonaqueous electrolyte secondary batteries such as a lithium secondary battery are currently in wide use as (i) batteries for devices such as a personal computer, a mobile telephone, and a portable information terminal or (ii) on-vehicle batteries.

As a separator for use in such a nonaqueous electrolyte secondary battery, a porous film containing polyolefin as a main component is mainly used.

For example, Patent Literature 1 discloses, as a porous base material useful for providing a nonaqueous electrolyte secondary battery separator excellent in ion permeability and mechanical strength, a polyethylene microporous film whose average pore diameter of void, porosity, puncture strength, and others are arranged to be in specific ranges.

### CITATION LIST

### Patent Literature

[Patent Literature 1]

Japanese Patent Application Publication, Tokukai, No. 2002-88188 (Publication Date: Mar. 27, 2002)

### SUMMARY OF INVENTION

### Technical Problem

A nonaqueous electrolyte secondary battery separator receives pressure during installation into a battery. In the conventional technique as described earlier, pressure applied to a separator during the installation into a battery is not taken into consideration. Therefore, in the conventional technique, deformation of voids due to the pressure leads to a decrease in air permeability. This can result in a decrease in mobility of lithium ions.

An aspect of the present invention has been attained in view of the above problem. It is an object of the present invention to provide a nonaqueous electrolyte secondary battery separator having a small difference in air permeability between before and after the application of pressure.

### Solution to Problem

A nonaqueous electrolyte secondary battery separator in accordance with an aspect of the present invention is a nonaqueous electrolyte secondary battery separator including a polyolefin porous film, the polyolefin porous film being such that an average of a crease resistance per weight per unit area in the TD and a crease resistance per weight per unit area in the MD is not less than 5.0% and that a difference between the crease resistance per weight per unit area in the TD and the crease resistance per weight per unit area in the MD is not more than 3.5%, wherein the crease resistance per weight per unit area is determined by the following expression (1):

Crease resistance per weight per unit area=crease recovery angle/weight per unit area/180×100 (1),

where the crease recovery angle is a value measured by a 4.9 N load method which is defined in JIS L 1059-1 (2009).

A nonaqueous electrolyte secondary battery laminated separator in accordance with an aspect of the present invention includes: a nonaqueous electrolyte secondary battery separator in accordance with an aspect of the present invention; and an insulating porous layer.

A nonaqueous electrolyte secondary battery member in accordance with an aspect of the present invention includes: a positive electrode; a nonaqueous electrolyte secondary battery separator in accordance with an aspect of the present invention or a nonaqueous electrolyte secondary battery laminated separator in accordance with an aspect of the present invention; and a negative electrode, the positive electrode, the nonaqueous electrolyte secondary battery separator or the nonaqueous electrolyte secondary battery laminated separator, and the negative electrode being arranged in this order.

A nonaqueous electrolyte secondary battery in accordance with an aspect of the present invention includes: a nonaqueous electrolyte secondary battery separator in accordance with an aspect of the present invention or a nonaqueous electrolyte secondary battery laminated separator in accordance with an aspect of the present invention.

### Advantageous Effects of Invention

According to an aspect of the present invention, it is possible to obtain a nonaqueous electrolyte secondary battery separator having a small difference in air permeability between before and after the application of pressure.

### BRIEF DESCRIPTION OF DRAWINGS

FIG. 1 is a diagram schematically illustrating a method of measuring crease recovery angle according to a 4.9 N load method.

FIG. 2 is a diagram schematically illustrating a method of measuring air permeability after the application of pressure.

### DESCRIPTION OF EMBODIMENTS

The following description will discuss an embodiment of the present invention. The present invention is, however, not limited to the embodiment below. The present invention is not limited to the arrangements described below, but may be altered in various ways by a skilled person within the scope of the claims. Any embodiment based on a proper combination of technical means disclosed in different embodiments is also encompassed in the technical scope of the present invention. Note that numerical expressions such as “A to B” herein mean “not less than A and not more than B” unless otherwise stated.

[1. Nonaqueous Electrolyte Secondary Battery Separator]

A nonaqueous electrolyte secondary battery separator in accordance with an embodiment of the present invention is a nonaqueous electrolyte secondary battery separator including a polyolefin porous film, the polyolefin porous film being such that an average of a crease resistance per weight per unit area in the TD and a crease resistance per weight per unit area in the MD is not less than 5.0% and that a difference between the crease resistance per weight per unit area in the TD and the crease resistance per weight per unit area in the MD is not more than 3.5%,

Note that a “machine direction (MD) (also referred to as ‘MD direction’) of a polyolefin porous film” as used herein means a conveyance direction in which a polyolefin porous film is conveyed during production of the polyolefin porous film. Note also that a “transverse direction (TD) (also referred to as ‘TD direction’) of a polyolefin porous film” as used herein means a direction perpendicular to the MD of a polyolefin porous film.

<Polyolefin Porous Film>

A nonaqueous electrolyte secondary battery separator in accordance with an embodiment of the present invention includes a polyolefin porous film, and is preferably constituted by a polyolefin porous film. The polyolefin porous film has therein many pores, connected to one another, so that a gas and a liquid can pass through the polyolefin porous film from one side to the other side. The polyolefin porous film can be a base material of the nonaqueous electrolyte secondary battery separator or a base material of a nonaqueous electrolyte secondary battery laminated separator, which will be described later. In a case where a battery generates heat, the polyolefin porous film melts so as to make the nonaqueous electrolyte secondary battery separator non-porous. Thus, the polyolefin porous film can impart a shutdown function to the nonaqueous electrolyte secondary battery separator.

Note, here, that the “polyolefin porous film” is a porous film which contains a polyolefin-based resin as a main component. Note that the phrase “contains a polyolefin-based resin as a main component” means that a porous film contains a polyolefin-based resin at a proportion of not less than 50% by volume, preferably not less than 90% by volume, more preferably not less than 95% by volume, relative to the whole of materials of which the porous film is made. Note also that, hereinafter, the polyolefin porous film is also simply referred to as a “porous film”.

Examples of the polyolefin-based resin which the porous film contains as a main component include, but are not particularly limited to, homopolymers and copolymers both of which are thermoplastic resins and are each produced through polymerization of a monomer(s) such as ethylene, propylene, 1-butene, 4-methyl-1-pentene, and/or 1-hexene. Specifically, examples of such homopolymers include polyethylene, polypropylene, and polybutene, and examples of such copolymers include an ethylene-propylene copolymer. The porous film can include a layer containing only one of these polyolefin-based resins and/or a layer containing two or more of these polyolefin-based resins. Among these, polyethylene is preferable as it is capable of preventing (shutting down) a flow of an excessively large electric current at a lower temperature. A high molecular weight polyethylene containing ethylene as a main component is particularly preferable. Note that the porous film can contain a component(s) other than polyolefin as long as such a component does not impair the function of the layer.

Examples of the polyethylene encompass low-density polyethylene, high-density polyethylene, linear polyethylene (ethylene-α-olefin copolymer), and ultra-high molecular weight polyethylene. Among these polyethylenes, a ultra-high molecular weight polyethylene is more preferable, and a ultra-high molecular weight polyethylene containing a high molecular weight component having a weight-average molecular weight of 5×10⁵ to 15×10⁶ is still more preferable. In particular, the polyolefin-based resin more preferably contains a high molecular weight component having a weight-average molecular weight of not less than 1,000,000 because such a polyolefin-based resin allows a porous film and a nonaqueous electrolyte secondary battery laminated separator to have a higher strength.

The porous film is such that an average of a crease resistance per weight per unit area in the TD and a crease resistance per weight per unit area in the MD is not less than 5.0% and that a difference between the crease resistance per weight per unit area in the TD and the crease resistance per weight per unit area in the MD is not more than 3.5%.

The crease resistance per weight per unit area refers to resistance to creasing i.e., the level of an ability of a porous film to recover from creasing. Here, the crease resistance per weight per unit area is determined by the following expression (1):

Crease resistance per weight per unit area=crease recovery angle/weight per unit area/180×100 (1),

In the expression (1), the crease recovery angle is a value measured by a 4.9 N load method which is defined in JIS L 1059-1 (2009).

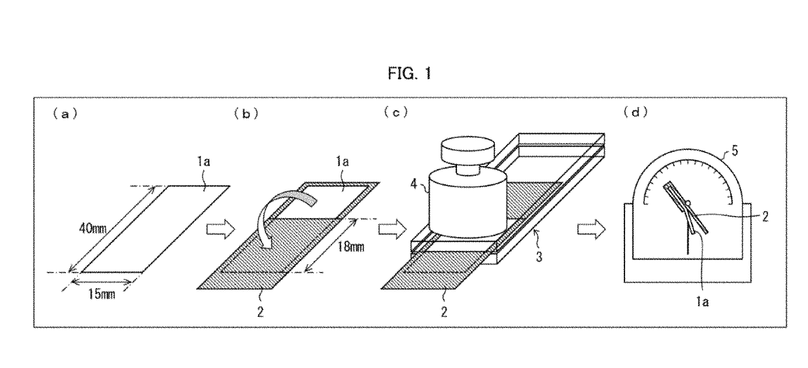

The following will describe the general outline of the 4.9 N load method. FIG. 1 is a diagram schematically illustrating a method of measuring crease recovery angle according to the 4.9 N load method. Here, the crease recovery angle is measured at 23° C. and at 50% RH. First, as illustrated in (a) of FIG. 1, a specimen 1a of 40 mm×15 mm is cut from a porous film.

Then, as illustrated in (b) of FIG. 1, the specimen 1a is inserted into a specimen holder 2. The specimen holder 2 has two metallic plates of different lengths which plates are fixed at one end. Here, the length of an inserted part of the specimen 1a into the specimen holder 2 is 18 mm in a longitudinal direction. Meanwhile, the length of an exposed part of the specimen 1a from the specimen holder 2 is 22 mm in the longitudinal direction. The exposed part of the specimen 1a from the specimen holder 2 is folded down.

Next, as illustrated in (c) of FIG. 1, the specimen holder 2 is placed inside a press holder 3 having a long side of 95 mm and a short side of 20 mm. A weight 4 weighing 500 g (i.e., 4.9 N) and having 40 mm in diameter is placed on the press holder 3 on an one end side where the specimen 1a is present. The press holder 3 has two plastic plates (e.g., acrylic plates) which are fixed at one end. The state in which the weight 4 is placed on the press holder 3 is kept for 5 minutes. Thereafter, the weight is removed, and the specimen holder 2 is taken out of the press holder 3.

As illustrated in (d) of FIG. 1, the specimen holder 2 is attached to a 4.9 N Monsant-type crease recovery angle measurement tester 5 while some care is taken to avoid contact with the specimen 1a. Here, the exposed part of the specimen 1 from the specimen holder 2 is adjusted so as to hang in a vertical direction at all times. This state is kept for 5 minutes. Thereafter, a numerical value (angle) marked on a protractor of the 4.9 N Monsant-type crease recovery angle measurement tester 5 is read. The angle thus read is regarded as the crease recovery angle. The crease recovery angle, which is an angle formed by both ends of the specimen 1a between which ends a crease of the specimen 1a is interposed, also referred to as opening angle. The measurement of the crease recovery angle is carried out three times under each condition. An average value of the measured values is substituted for the crease recovery angle in the above expression (1) to calculate a crease resistance per weight per unit area. As the 4.9 N Monsant-type crease recovery angle measurement tester 5, for example, a Monsant recovery tester (manufactured by Daiei Kagaku Seiki MFG Co., Ltd.; Type: MR-1) can be used.

Note that the weight per unit area refers to a weight per square meter of the porous film.

The “crease resistance per weight per unit area in the TD” as used herein means a crease resistance per weight per unit area which crease resistance is obtained by using a specimen having been prepared from a porous film so that the TD of the porous film is a longitudinal direction (40 mm) of the specimen. Further, the “crease resistance per weight per unit area in the MD” as used herein means a crease resistance per weight per unit area which crease resistance is obtained by using a specimen having been prepared from a porous film so that the MD of the porous film is a longitudinal direction (40 mm) of the specimen.

The “average of a crease resistance per weight per unit area in the TD and a crease resistance per weight per unit area in the MD is not less than 5.0%” indicates that a value determined by the expression (2) below is not less than 5.0%.

(Crease resistance per weight per unit area in the TD+Crease resistance per weight per unit area in the MD)/2 (2)

The “average of a crease resistance per weight per unit area in the TD and a crease resistance per weight per unit area in the MD” is also referred to as “average crease resistance”. In a case where the average crease resistance is too low, a resin having holes is low in strength and has a low level of ability to allow the holes to recover their original shapes. Thus, it is likely that holes of a porous film remain deformed due to a stress applied during electrode assembly or battery assembly. This can easily lead to a decrease in mobility of lithium ions. In a case where the average crease resistance is not less than 5.0%, holes of a porous film can easily recover their original shapes even when the holes are deformed under stress applied during electrode assembly or battery assembly. Thus, the mobility of lithium ions is less likely to decrease. The average crease resistance is preferably not less than 5.5%, more preferably not less than 6.0%. An upper limit of the average crease resistance is not limited to any particular value, but can be, for example, not more than 8.0%.

A nonaqueous electrolyte secondary battery separator in accordance with an embodiment of the present invention preferably has not only a high crease resistance of a porous film and but also a small crease resistance difference. The “difference between the crease resistance per weight per unit area in the TD and the crease resistance per weight per unit area in the MD is not more than 3.5%” indicates that a value determined by the expression (3) below is not more than 3.5%.

|Crease resistance per weight per unit area in the TD−Crease resistance per weight per unit area in the MD| (3)

The “difference between a crease resistance per weight per unit area in the TD and a crease resistance per weight per unit area in the MD” is also referred to as “crease resistance difference”. Depending on stretching conditions of a porous film, anisotropy of holes of a porous film can occur between the TD and the MD. Accordingly, the holes tend to be deformed in a certain direction. Moreover, a nonaqueous electrolyte secondary battery separator can be installed while it is pushed against a member having curved surface or a corner. In a case where the crease resistance difference is too large even when the average crease resistance is high, holes of a porous film are deformed during the installation so as to be expanded in a long axis direction of the holes. This decreases openings of the holes. Thus, it is likely that mobility of lithium ions is decreased locally. In a case where the crease resistance difference is not more than 3.5%, anisotropy of the holes is small. Thus, even when a stress is applied during electrode assembly or battery assembly, it is possible to prevent the holes from being deformed in one direction. Thus, the mobility of lithium ions is less likely to decrease. The crease resistance difference is preferably not more than 3.0%, more preferably not more than 2.0%, still more preferably not more than 1.0%. Note that a value determined by the expression (4) may be fall within the above range.

(Crease resistance per weight per unit area in the TD−Crease resistance per weight per unit area in the MD) (4)

The porous film has a thickness of preferably 4 μm to 40 μm, more preferably 5 μm to 20 μm. It is preferable that the porous film have a thickness of not less than 4 μm because it is possible to sufficiently prevent an internal short circuit of a battery. Meanwhile, it is preferable that the porous film have a thickness of not more than 40 μm because it is possible to prevent a nonaqueous electrolyte secondary battery from being large in size.

The porous film typically has a weight per unit area of preferably 4 g/m² to 20 g/m², more preferably 5 g/m² to 12 g/m², so as to allow a nonaqueous electrolyte secondary battery to have a higher weight energy density and a higher volume energy density.

The porous film has an air permeability of preferably 30 sec/100 mL to 500 sec/100 mL, more preferably 50 sec/100 mL to 300 sec/100 mL, in terms of Gurley values. This allows a nonaqueous electrolyte secondary battery separator to have sufficient ion permeability.

The porosity of the porous film is preferably 20% by volume to 80% by volume, and more preferably 30% by volume to 75% by volume. This makes it possible to (i) retain a larger amount of electrolyte and (ii) reliably prevent (shut down) a flow of an excessively large electric current at a lower temperature.

The pore diameter of each of the pores of the porous film is preferably not more than 0.3 μm, more preferably not more than 0.14 μm. This allows the nonaqueous electrolyte secondary battery separator to achieve sufficient ion permeability and to prevent particles, constituting an electrode, from entering the nonaqueous electrolyte secondary battery separator.

[Method for Producing Porous Film]

Examples of a method for producing a porous film include, but are not particularly limited to, a method in which a polyolefin-based resin and an additive are melt-kneaded and are then extruded to obtain a sheet-shaped polyolefin resin composition, and the sheet-shaped polyolefin resin composition is stretched.

Specifically, the method can include the following steps of:

(A) melt-kneading a polyolefin-based resin and an additive in a kneader to obtain a polyolefin resin composition;
(B) extruding, through a T-die of an extruder, the melted polyolefin resin composition having been obtained in the step (A), and then shaping the polyolefin resin composition into a sheet while cooling the polyolefin resin composition, so that a sheet-shaped polyolefin resin composition is obtained;
(C) stretching the sheet-shaped polyolefin resin composition having been obtained in the step (B);
(D) cleaning, with use of a cleaning liquid, the polyolefin resin composition having been stretched in the step (C);
(E) drying and/or heat fixing the polyolefin resin composition having been cleaned in the step (D), so that a polyolefin porous film is obtained.

Note that the cleaning step (step (D)) may be performed before the stretching step (step (C)).

In the step (A), the polyolefin-based resin is used in an amount of preferably 5% by weight to 50% by weight, more preferably 10% by weight to 30% by weight, with respect to 100% by weight of the obtained polyolefin resin composition.

Examples of the additive in the step (A) include: water-soluble inorganic compounds such as calcium carbonate; phthalate esters such as dioctyl phthalate; unsaturated higher alcohol such as oleyl alcohol; saturated higher alcohol such as stearyl alcohol; low molecular weight polyolefin-based resin such as paraffin wax; petroleum resin; and liquid paraffin. Examples of the petroleum resin include: (i) an aliphatic hydrocarbon resin obtained through polymerization of a C5 petroleum fraction such as isoprene, pentene, and pentadiene as a principal material; (ii) an aromatic hydrocarbon resin obtained through polymerization of a C9 petroleum fraction such as indene, vinyltoluene, and methyl styrene; (iii) copolymer resins of the aliphatic hydrocarbon resin and the aromatic hydrocarbon resin; (iv) alicyclic saturated hydrocarbon resins obtained through hydrogenation of the resins (i) to (iii); and (v) varying mixtures of the resins (i) to (iv). These additives may be used alone or may be used in combination. Among these additives, a combination of (i) any of water-soluble inorganic compounds or liquid paraffin, which serve as a pore forming agent, and (ii) a petroleum resin is preferably used.

Stretching can be performed in the step (C) only or can alternatively be performed in both of the steps (B) and (C). Stretching is preferably performed both in the MD direction and in the TD direction. Stretching can be performed by a method in which chucks hold both sides of the sheet to stretch the sheet, by a method in which a roller conveys the sheet at different rotational speeds so that the sheet is stretched, or by a method in which the sheet is rolled with use of a pair of rollers.

In a case where stretching is performed in the step (C) only, stretching in the MD direction can be followed by stretching in the TD direction (sequential biaxial stretching), or alternatively, stretching in the MD direction and stretching in the TD direction can be performed simultaneously (simultaneous biaxial stretching). In a case where stretching is performed in both of the steps (B) and (C), it is preferable that stretching in the MD direction be performed in the step (B), and then stretching in the MD direction and/or stretching in the TD direction be performed in the step (C).

A strain rate during the stretching is performed at preferably 150%/min to 3000%/min, more preferably 200%/min to 2400%/min. Furthermore, a difference between the strain rate during the stretching in the MD direction (MD strain rate) and the strain rate during the stretching in the TD direction (TD strain rate) is controlled to fall within a range of preferably 0%/min to 1600%/min, more preferably 200%/min to 1200%/min.

The stretch magnification at which stretching is performed in the MD direction is preferably not less than 1.2 times to less than 7 times, more preferably not less than 1.4 times to not more than 6.5 times.

The stretch magnification at which stretching is performed in the TD direction is preferably not less than 3 times to less than 7 times, more preferably not less than 4.5 times to not more than 6.5 times.

The stretch temperature is preferably not higher than 130° C., more preferably 110° C. to 120° C.

The cleaning liquid used in the step (D) can be any solvent that can remove an unnecessary additive such as a pore forming agent. Examples of the cleaning liquid include an aqueous hydrochloric acid solution, heptane, and dichloromethane.

In the step (E), the cleaned polyolefin resin composition is dried and/or subjected to heat treatment at a specific temperature for heat fixing. A drying temperature during the drying is preferably room temperature. The heat fixing is performed at a temperature of preferably not lower than 110° C. to not higher than 140° C., more preferably not lower than 115° C. to not higher than 135° C. The heat fixing is performed for a time of preferably not shorter than 0.5 minutes to not longer than 60 minutes, more preferably not shorter than 1 minute to not longer than 30 minutes.

In a method for producing the porous film, adjusting the additive(s) and the strain rate makes it possible to suitably control (i) anisotropy of voids (holes) of a resultant porous film and (ii) the strength of a resin having voids. Examples of the strain rate adjustment encompass an adjustment in which, particularly in the case where biaxial stretching is performed, strain rates in respective axial directions of stretching are adjusted as appropriate to fall within any of the above ranges. Consequently, the crease resistance per weight per unit area of the porous film can be controlled to fall within a suitable range.

[2. Nonaqueous Electrolyte Secondary Battery Laminated Separator]

According to another embodiment of the present invention, it is possible to use, as a separator, a nonaqueous electrolyte secondary battery laminated separator including (i) the nonaqueous electrolyte secondary battery separator and (ii) an insulating porous layer. Since the porous film is as described earlier, the insulating porous layer is described here. Note that, hereinafter, the insulating porous layer is also simply referred to as a “porous layer”.

<Porous Layer>

The porous layer is normally a resin layer containing a resin and is preferably a heat-resistant layer or an adhesion layer. The resin of which the porous layer is made is preferably a resin that (i) has a function desired for the porous layer, that (ii) is insoluble in an electrolyte of a battery, and that (iii) is electrochemically stable when the battery is in normal use.

The porous layer is disposed on one surface or both surfaces of the nonaqueous electrolyte secondary battery separator as necessary. In a case where the porous layer is disposed on one surface of the porous film, the porous layer is preferably disposed on that surface of the porous film which surface faces a positive electrode of a nonaqueous electrolyte secondary battery to be produced, more preferably on that surface of the porous film which surface comes into contact with the positive electrode.

Examples of the resin of which the porous layer is made encompass: polyolefins; (meth)acrylate-based resins; fluorine-containing resins; polyamide-based resins; polyimide-based resins; polyester-based resins; rubbers; resins with a melting point or glass transition temperature of not lower than 180° C.; and water-soluble polymers.

Among the above resins, polyolefins, polyester-based resins, acrylate-based resins, fluorine-containing resins, polyamide-based resins, and water-soluble polymers are preferable. As the polyamide-based resins, wholly aromatic polyamides (aramid resins) are preferable. As the polyester resins, polyarylates and liquid crystal polyesters are preferable.

The porous layer may contain fine particles. The term “fine particles” herein means organic fine particles or inorganic fine particles generally referred to as a filler. Therefore, in a case where the porous layer contains fine particles, the above resin contained in the porous layer has a function as a binder resin for binding (i) fine particles together and (ii) fine particles and the porous film. The fine particles are preferably electrically insulating fine particles.

Examples of the organic fine particles contained in the porous layer encompass resin fine particles.

Specific examples of the inorganic fine particles contained in the porous layer encompass fillers made of inorganic matters such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, and glass. These inorganic fine particles are electrically insulating fine particles. The porous layer may contain (i) only one kind of the fine particles or (ii) two or more kinds of the fine particles in combination.

Among the above fine particles, fine particles made of an inorganic matter is suitable. Fine particles made of an inorganic oxide such as silica, calcium oxide, magnesium oxide, titanium oxide, alumina, mica, zeolite, aluminum hydroxide, or boehmite are preferable. Further, fine particles made of at least one kind selected from the group consisting of silica, magnesium oxide, titanium oxide, aluminum hydroxide, boehmite, and alumina are more preferable. Fine particles made of alumina are particularly preferable.

A fine particle content of the porous layer is preferably 1% by volume to 99% by volume, and more preferably 5% by volume to 95% by volume with respect to 100% by volume of the porous layer. In a case where the fine particle content falls within these ranges, it is less likely for a void, which is formed when fine particles come into contact with each other, to be blocked by a resin or the like. This makes it possible to achieve sufficient ion permeability and a proper weight per unit area of the porous film.

The porous layer may include a combination of two or more kinds of fine particles which differ from each other in particle and/or specific surface area.

A thickness of the porous layer is preferably 0.5 μm to 15 μm (per surface of the nonaqueous electrolyte secondary battery laminated separator), and more preferably 2 μm to 10 μm (per surface of the nonaqueous electrolyte secondary battery laminated separator).

In a case where the thickness of the porous layer is less than 1 μm, it may not be possible to sufficiently prevent an internal short circuit caused by breakage or the like of a battery. In addition, an amount of electrolyte to be retained by the porous layer may decrease. In contrast, if a total thickness of porous layers on both surfaces of the nonaqueous electrolyte secondary battery separator is above 30 μm, then a rate characteristic and/or a cycle characteristic may deteriorate.

The weight per unit area of the porous layer (per surface of the nonaqueous electrolyte secondary battery laminated separator) is preferably 1 g/m² to 20 g/m², and more preferably 4 g/m² to 10 g/m².

A volume per square meter of a porous layer constituent component contained in the porous layer (per surface of the nonaqueous electrolyte secondary battery laminated separator) is preferably 0.5 cm³ to 20 cm³, more preferably 1 cm³ to 10 cm³, still more preferably 2 cm³ to 7 cm³.

For the purpose of obtaining sufficient ion permeability, a porosity of the porous layer is preferably 20% by volume to 90% by volume, and more preferably 30% by volume to 80% by volume. In order for a nonaqueous electrolyte secondary battery laminated separator to obtain sufficient ion permeability, a pore diameter of each of pores of the porous layer is preferably not more than 3 μm, and more preferably not more than 1 μm.

The nonaqueous electrolyte secondary battery laminated separator in accordance with an embodiment of the present invention has a thickness of preferably 5.5 μm to 45 μm, more preferably 6 μm to 25 μm.

The nonaqueous electrolyte secondary battery laminated separator in accordance with an embodiment of the present invention has an air permeability of preferably 30 sec/100 mL to 1000 sec/100 mL, more preferably 50 sec/100 mL to 800 sec/100 mL in terms of Gurley values.

<Method for Producing Porous Layer>

Examples of a method for producing the porous layer encompass a method in which (i) a surface of the porous film described earlier is coated with a coating solution described later and then (ii) the coating solution is dried so as to precipitate the porous layer.

The coating solution for use in a method for producing a porous layer can be prepared normally by (i) dissolving, in a solvent, a resin and (ii) dispersing, in the solvent, fine particles. Here, the solvent for dissolving the resin also serves as a disperse medium for dispersing fine particles. Here, the resin can be contained as an emulsion, without being dissolved in the solvent.

The solvent can be any solvent which (i) does not adversely influence the porous film, (ii) allows the resin to be dissolved uniformly and stably, and (iii) allows the fine particles to be dispersed uniformly and stably. Specific examples of the solvent encompass water and an organic solvent. It is possible to use (i) only one kind of the above solvents or (ii) two or more kinds of the above solvents in combination.

The coating solution can be formed by any method, provided that the coating solution can satisfy conditions such as a resin solid content (resin concentration) or an amount of the fine particles, each of which conditions is necessary to obtain a desired porous layer. Specific examples of the method for preparing the coating solution encompass a mechanical stirring method, an ultrasonic dispersion method, a high-pressure dispersion method, and a media dispersion method. The coating solution can contain an additive(s) such as a disperser, a plasticizer, a surfactant, and a pH adjusting agent as a component(s) other than the resin and the fine particles as long as such an additive(s) does not impair an object of the present invention.

The coating solution can be applied to the porous film by any method, that is, a porous layer can be formed by any method on a surface of a polyolefin porous film. The porous layer may be formed on a surface of a porous film that has been subjected to a hydrophilization treatment as necessary.

Examples of the method for forming the porous layer encompass: a method in which a surface of a porous film is directly coated with a coating solution, and then a solvent (dispersion medium) is removed; a method in which an appropriate support is coated with a coating solution, a solvent (dispersion medium) is removed so as to form a porous layer, and then the porous layer and a porous film are bonded together by pressure, and then the support is peeled off; and a method in which an appropriate support is coated with a coating solution, then a porous film is bonded to the coated surface by pressure, then the support is peeled off, and then the solvent (dispersion medium) is removed.

A method of applying the coating solution can be a conventionally known method. Specific examples of the method encompass a gravure coater method, a dip coater method, a bar coater method, and a die coater method.

The solvent is typically removed by a drying method. The solvent contained in the coating solution can be replaced with another solvent before a drying operation.

[3. Nonaqueous Electrolyte Secondary Battery Member]

A nonaqueous electrolyte secondary battery member in accordance with an embodiment of the present invention includes a positive electrode, the nonaqueous electrolyte secondary battery separator described earlier or the nonaqueous electrolyte secondary battery laminated separator described earlier, and a negative electrode which are arranged in this order.

<Positive Electrode>

The positive electrode is not limited to any particular one, provided that the positive electrode is one that is typically used as a positive electrode of a nonaqueous electrolyte secondary battery. Examples of the positive electrode encompass a positive electrode sheet having a structure in which an active material layer containing a positive electrode active material and a binding agent is formed on a current collector. The active material layer can further contain an electrically conductive agent and/or a binding agent.

Examples of the positive electrode active material encompass a material capable of being doped and dedoped with lithium ions. Specific examples of such a material include a lithium complex oxide containing at least one transition metal such as V, Mn, Fe, Co, or Ni.

Examples of the electrically conductive agent encompass carbonaceous materials such as natural graphite, artificial graphite, cokes, carbon black, pyrolytic carbons, carbon fiber, and a fired product of an organic polymer compound. It is possible to use (i) only one kind of the above electrically conductive agents or (ii) two or more kinds of the above electrically conductive agents in combination.

Examples of the binding agent encompass (i) fluorine-based resins such as polyvinylidene fluoride, (ii) acrylic resin, and (iii) styrene butadiene rubber. Note that the binding agent serves also as a thickener.

Examples of the positive electrode current collector encompass electric conductors such as Al, Ni, and stainless steel. Among these, Al is more preferable because Al is easily processed into a thin film and is inexpensive.

Examples of a method for producing the positive electrode sheet encompass: a method in which a positive electrode active material, an electrically conductive agent, and a binding agent are pressure-molded on a positive electrode current collector; and a method in which (i) a positive electrode active agent, an electrically conductive agent, and a binding agent are formed into a paste with the use of a suitable organic solvent, (ii) a positive electrode current collector is coated with the paste, and then (iii) the paste is dried and then pressured so that the paste is firmly fixed to the positive electrode current collector.

<Negative Electrode>

The negative electrode is not limited to any particular one, provided that the negative electrode is one that is typically used as a negative electrode of a nonaqueous electrolyte secondary battery. Examples of the negative electrode encompass a negative electrode sheet having a structure in which an active material layer containing a negative electrode active material and a binder resin is formed on a current collector. The active material layer can further contain an electrically conductive agent.

Examples of the negative electrode active material encompass (i) a material capable of being doped and dedoped with lithium ions, (ii) a lithium metal, and (iii) a lithium alloy. Examples of the material encompass carbonaceous materials. Examples of the carbonaceous materials encompass natural graphite, artificial graphite, cokes, carbon black, and pyrolytic carbons.

Examples of the negative electrode current collector encompass Cu, Ni, and stainless steel. Among these, Cu is more preferable because Cu is not easily alloyed with lithium especially in the case of a lithium ion secondary battery and is easily processed into a thin film.

Examples of a method for producing the negative electrode sheet encompass: a method in which a negative electrode active material is pressure-molded on a negative electrode current collector; and a method in which (i) a negative electrode active material is formed into a paste with the use of a suitable organic solvent, (ii) a negative electrode current collector is coated with the paste, and then (iii) the paste is dried and then pressured so that the paste is firmly fixed to the negative electrode current collector.

The paste preferably contains the electrically conductive agent and the binding agent.

A nonaqueous electrolyte secondary battery member in accordance with an embodiment of the present invention can be produced by, for example, arranging the above positive electrode, the above-described nonaqueous electrolyte secondary battery separator or the above-described nonaqueous electrolyte secondary battery laminated separator, and the above negative electrode in this order. The nonaqueous electrolyte secondary battery member may be produced by any method, and may be produced by a conventionally publicly known method.

[4. Nonaqueous Electrolyte Secondary Battery]

A nonaqueous electrolyte secondary battery in accordance with an embodiment of the present invention includes the above-described nonaqueous electrolyte secondary battery separator or the above-described nonaqueous electrolyte secondary battery laminated separator.

The nonaqueous electrolyte secondary battery may be produced by any method, and may be produced by a conventionally publicly known method. For example, a nonaqueous electrolyte secondary battery member is produced by the method described above, and then the nonaqueous electrolyte secondary battery member is inserted into a container that serves as a housing of a nonaqueous electrolyte secondary battery. Subsequently, the container is filled with a nonaqueous electrolyte, and is then hermetically sealed under reduced pressure. This produces a nonaqueous electrolyte secondary battery in accordance with an embodiment of the present invention.

<Nonaqueous Electrolyte>

The nonaqueous electrolyte is not limited to any particular one, provided that the nonaqueous electrolyte is one that is typically used as a nonaqueous electrolyte of a nonaqueous electrolyte secondary battery. Examples of the nonaqueous electrolyte include a nonaqueous electrolyte prepared by dissolving a lithium salt in an organic solvent. Examples of the lithium salt encompass LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAIC₄. It is possible to use (i) only one kind of the above lithium salts or (ii) two or more kinds of the above lithium salts in combination.

Examples of the organic solvent to be contained in the nonaqueous electrolyte encompass carbonates, ethers, esters, nitriles, amides, carbamates, a sulfur-containing compound, and a fluorine-containing organic solvent obtained by introducing a fluorine group into any of these organic solvents. It is possible to use (i) only one kind of the above organic solvents or (ii) two or more kinds of the above organic solvents in combination.

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

The following description will discuss the present invention in greater detail with reference to Examples and Comparative Example. Note, however, that the present invention is not limited to the Examples and Comparative Example below.

[Measurement]

In the Examples and Comparative Examples below, the average crease resistance and crease resistance difference and the difference in air permeability between before and after the application of pressure were measured by the following methods. These measurements were carried out at 23° C. and at 50% RH. Note that the difference in air permeability between before and after the application of pressure is an index that reflects a decrease in mobility of lithium ions.

<Average Crease Resistance and Crease Resistance Difference>

A crease resistance per weight per unit area was determined based on a crease recovery angle measured by the 4.9 N load method, which is defined in JIS L 1059-1 (2009). The 4.9 N load method is specifically described below.

A porous film was cut into a piece of 15 mm×40 mm to prepare a specimen. The specimen was inserted into a metal plate holder which was included in a Monsant recovery tester (manufactured by Daiei Kagaku Seiki MFG Co., Ltd.; Type: MR-1). At this time, the length of an inserted part of the specimen into the metal plate holder was 18 mm in a longitudinal direction.

Next, an exposed part of the specimen from the metal plate holder was folded down. The metal plate holder consists of two metal plates of different lengths. The specimen was folded along one end of a shorter metal plate.

Further, the metal plate holder was placed inside a plastic press holder having a long side of 95 mm and a short side of 20 mm. In placing the metal plate holder inside the plastic press holder, a folded part of the specimen was overlapped with the plastic press holder. Subsequently, a weight having a weight of 500 g and having a diameter of 40 mm was placed on one end of the plastic press holder where the specimen was present inside the plastic press holder. Five minutes later, the weight was removed, and then the metal plate holder was taken out of the plastic press holder.

Thereafter, the metal plate holder with the specimen placed inside was turned back and was then inserted into a metal plate holder support of the Monsant recovery tester. In inserting the metal plate holder into the Monsant recovery tester, the exposed part of the specimen from the metal plate holder was adjusted so as to point in the vertical downward direction. A rotating plate of the Monsant recovery tester was rotated to bring a suspended part of the specimen into line with a perpendicular line in the center of the Monsant recovery tester at all times. Five minutes later, a numerical value marked on a protractor of the Monsant recovery tester was read. The numerical value thus read was regarded as the crease recovery angle. Note that the measurement of the crease recovery angle was carried out on a specimen prepared from a porous film so that the TD of the porous film was a longitudinal direction (40 mm) of the specimen and on a specimen prepared from a porous film so that the MD of the porous film was a longitudinal direction (40 mm) of the specimen. The measurement of the crease recovery angle was carried out three times under each condition. An average value of the measured values was substituted into the above expression (1) to calculate crease resistance per weight per unit area.

Based on the obtained crease resistance per weight per unit area, the average crease resistance and crease resistance difference were calculated, respectively, by the expressions (2) and (3) described earlier.

<Difference in Air Permeability Between Before and after Application of Pressure>

A porous film was cut into a piece of 40 mm×40 mm to prepare a specimen. The specimen was placed inside a measurement section of a digital Oken-type air permeability tester EGO1 manufactured by Asahi Seiko Co., Ltd., to measure the air permeability before the application of pressure.

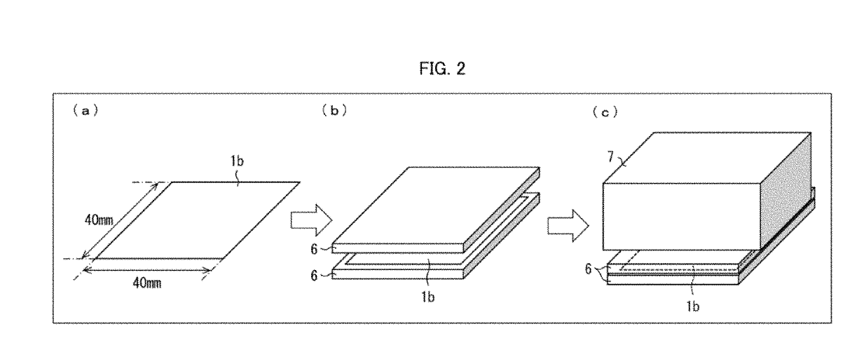

Next, a method for measuring air permeability before and after the application of pressure will be described with reference to FIG. 2. (a) of FIG. 2 illustrates a specimen 1b which was subjected to the measurement of air permeability before the application of pressure. As illustrated in (b) of FIG. 2, the specimen 1b was sandwiched between two SUS plates (upper and lower SUS plates) 6 (SUS303; 50 mm long×50 mm wide×1 mm thick) and was then placed on a flat testing bench. Thereafter, as illustrated in (c) of FIG. 2, a weight 7 was placed on the upper SUS plate 6 so that a total load of 2 kg, including the weights of the weight 7 and of the upper SUS plate 6, was applied to the specimen 1b. In this way, the application of pressure was performed for 5 minutes. After the 5 minutes of pressure application, the weight 7 and the upper and lower SUS plates 6 were removed. After a lapse of 20 seconds from the removal, air permeability after the application of pressure was measured by use of the air permeability tester. As a difference in air permeability between before and after the application of pressure, was used a value obtained by subtracting the air permeability before the application of pressure from the air permeability after the application of pressure.

[Production of Nonaqueous Electrolyte Secondary Battery Separator]

### Example 1

68/a % by weight of ultra-high molecular weight polyethylene powder (GUR2024, manufactured by Ticona Corporation) and 32% by weight of polyethylene wax (FNP-0115, manufactured by Nippon Seiro Co., Ltd.) having a weight-average molecular weight of 1,000 were prepared. Assuming that a total amount of a mixture of the ultra-high molecular weight polyethylene and the polyethylene wax was 100 parts by weight, 0.4 parts by weight of an antioxidant (Irg1010, manufactured by Ciba Specialty Chemicals Corporation), 0.1 parts by weight of an antioxidant (P168, manufactured by Ciba Specialty Chemicals Corporation), and 1.3 parts by weight of sodium stearate were added to the 100 parts by weight of the mixture. Then, calcium carbonate (manufactured by Maruo Calcium Co., Ltd.) having an average particle diameter of 0.1 μm was further added so as to account for 38% by volume of a total volume of the resultant mixture. Then, the resultant mixture while remaining in the form of powder was mixed in a Henschel mixer, and thereafter the mixture was melt-kneaded by use of a twin screw kneader. This produced a polyolefin resin composition.

The polyolefin resin composition was stretched to 1.4 times in the MD direction by use of a roller at an MD strain rate of 290%/min, so that a sheet was obtained. The sheet thus obtained was immersed in an aqueous hydrochloric acid solution (containing 4 mol/L of hydrochloric acid and 0.5/% by weight of nonionic surfactant) for removal of the calcium carbonate. Subsequently, at a TD strain rate of 1300%/min, the sheet was stretched to 6.2 times in the TD direction at 105° C. This produced a nonaqueous electrolyte secondary battery separator having a weight per unit area of 6.4 g/m². Difference between the MD strain rate and the TD strain rate was 1010%/min.

### Example 21

18% by weight of ultra-high molecular weight polyethylene powder (Hi-zex Million 145M, manufactured by Mitsui Chemicals, Inc.) and 2% by weight of petroleum resin (hydrogenated type; melting point: 131° C.; softening point: 90° C.) containing vinyltoluene, indene, and α-methyl styrene were prepared. Powder of these ingredients was crushed and mixed by a blender until the powder had a uniform particle diameter. A resultant mixed powder was fed into a twin screw kneader through a quantitative feeder and was melt-kneaded. Thereafter, a resultant product was extruded from a T-die through a gear pump. This produced a polyolefin resin composition in the form of a sheet. At this time, 80% by weight of additive (liquid paraffin) was side-fed into the twin screw kneader under pressure with a pump.

The resultant polyolefin resin composition in the form of a sheet was stretched to 6.4 times in the MD direction at 117° C. At this time, the MD strain rate was 700%/min. Subsequently, the polyolefin resin composition in the form of a sheet was stretched to 6.0 times in the TD direction at 115° C. At this time, the TD strain rate was 500%/min. Difference between the MD strain rate and the TD strain rate was 200%/min. The stretched polyolefin resin composition in the form of a sheet was immersed in heptane for cleaning. The polyolefin resin composition was dried at room temperature, and was then heat-fixed in an oven at 132° C. for 5 minutes. This produced a nonaqueous electrolyte secondary battery separator having a weight per unit area of 8.5 g/m².

### Example 3

18% by weight of ultra-high molecular weight polyethylene powder (Hi-zex Million 145M, manufactured by Mitsui Chemicals, Inc.) and 2% by weight of petroleum resin (hydrogenated type; melting point: 164° C.; softening point: 125° C.) containing vinyltoluene, indene, and α-methyl styrene were prepared. Powder of these ingredients was crushed and mixed by a blender until the powder had a uniform particle diameter. A resultant mixed powder was fed into a twin screw kneader through a quantitative feeder and was melt-kneaded. Thereafter, a resultant product was extruded from a T-die through a gear pump. This produced a polyolefin resin composition in the form of a sheet. At this time, 80% by weight of additive (liquid paraffin) was side-fed into the twin screw kneader under pressure with a pump.

The resultant polyolefin resin composition in the form of a sheet was stretched to 6.4 times in the MD direction at 117° C. At this time, the MD strain rate was 700%/min. Subsequently, the polyolefin resin composition in the form of a sheet was stretched to 6.0 times in the TD direction at 115° C. At this time, the TD strain rate was 500%/min. Difference between the MD strain rate and the TD strain rate was 200%/min. The stretched polyolefin resin composition in the form of a sheet was immersed in heptane for cleaning. The polyolefin resin composition was dried at room temperature, and was then heat-fixed in an oven at 132° C. for 5 minutes. This produced a nonaqueous electrolyte secondary battery separator having a weight per unit area of 7.0 g/m².

### Comparative Example 1

A commercially available polyolefin porous film (manufactured by Celgard, LLC; #2400) was used as a nonaqueous electrolyte secondary battery separator.

### Comparative Example 2

A nonaqueous electrolyte secondary battery separator having a weight of 5.4 g/m² was obtained by the same method as in Example 1 except for the following points:

As the ultra-high molecular weight polyethylene powder, 72% by weight of GUR4032 manufactured by Ticona Corporation was used.

28% by weight of polyethylene wax was used.

37% by volume of calcium carbonate was used.

The MD strain rate was 470%/min.

After removal of calcium carbonate, stretching was performed at the stretch magnification of 7.0 times.

The TD strain rate was 2100%/min.

Difference between the MD strain rate and the TD strain rate was 1630%/min.

[Measurement Results]

Table 1 shows the measurement results.

TABLE 1

| | | | | | Difference |
|---|---|---|---|---|---|
| | | | | | in air |
| | | Crease | | | permeability |
| | Crease | resist- | | | between |
| | resistance | ance | | | before |
| | per | per | | | and after |
| | weight | weight | Average | Crease | application |
| | per unit | per unit | crease | resistance | of |
| | area in | area in | resistance | difference | pressure |
| | MD [%] | TD [%] | [%] | [%] | [sec/100 mL] |
| Comparative | 3.6 | 4.7 | 4.2 | 1.1 | 11.2 |
| Example 1 | | | | | |
| Comparative | 6.4 | 10.1 | 8.3 | 3.7 | 6.4 |
| Example 2 | | | | | |
| Example 1 | 6.0 | 6.2 | 6.1 | 2.8 | 2.1 |
| Example 2 | 5.4 | 7.0 | 6.1 | 0.2 | 0.4 |
| Example 3 | 4.7 | 7.4 | 6.2 | 1.6 | 0.9 |

Comparative Example 1, which shows that the crease resistance difference was not more than 3.5%, but the average crease resistance was less than 5.0%, shows that the difference in air permeability between before and after the application of pressure was 11 sec/100 mL. This is considered to be caused because a low crease resistance led to deformation of holes of the porous film under stress during the application of pressure and thus resulted in a significant decrease in air permeability after the application of pressure.

Moreover, Comparative Example 2, which shows that the average crease resistance was not less than 5.0%, but the crease resistance difference exceeded 3.5%, shows that the difference in air permeability between before and after the application of pressure was not less than 6 sec/100 mL. This is considered to be caused because deformation of holes, of the porous film, having a large anisotropy in one direction during the application of pressure decreased openings of the holes and thus resulted in a significant decrease in air permeability after the application of pressure.

In contrast, Examples 1 through 3, which show that the average crease resistance was not less than 5.0%, and the crease resistance difference was not more than 3.5%, show that the difference in air permeability between before and after the application of pressure was less than 2.5%. This confirms that Examples 1 through 3 prevented a decrease in air permeability after the application of pressure in comparison with Comparative Examples 1 and 2. Particularly in Examples 2 and 3 showing that the crease resistance difference was not more than 2.0%, the crease resistance difference before and after the application of pressure was less than 1.0 sec/100 mL.

### INDUSTRIAL APPLICABILITY

A nonaqueous electrolyte secondary battery separator in accordance with an embodiment of the present invention and a nonaqueous electrolyte secondary battery laminated separator in accordance with an embodiment of the present invention are suitably usable in production of a nonaqueous electrolyte secondary battery which prevents a decrease in air permeability after the application of pressure.

### REFERENCE SIGNS LIST

1a, 1b: Specimen
2: Specimen holder
3: Press holder
4: Weight
5: 4.9 N Monsant-type crease recovery angle measurement tester
6: SUS plate
7: Weight

1. A nonaqueous electrolyte secondary battery separator comprising a polyolefin porous film,
the polyolefin porous film being such that an average of a crease resistance per weight per unit area in the TD and a crease resistance per weight per unit area in the MD is not less than 5.0% and that a difference between the crease resistance per weight per unit area in the TD and the crease resistance per weight per unit area in the MD is not more than 3.5%,
wherein the crease resistance per weight per unit area being determined by the following expression (1):
Crease resistance per weight per unit area=crease recovery angle/weight per unit area/180×100 (1),
where the crease recovery angle is a value measured by a 4.9 N load method which is defined in JIS L 1059-1 (2009).

2. A nonaqueous electrolyte secondary battery laminated separator comprising:
a nonaqueous electrolyte secondary battery separator recited in claim 1; and
an insulating porous layer.

3. A nonaqueous electrolyte secondary battery member comprising:
a positive electrode;
a nonaqueous electrolyte secondary battery separator recited in claim 1; and
a negative electrode,
the positive electrode, the nonaqueous electrolyte secondary battery separator, and the negative electrode being arranged in this order.

4. A nonaqueous electrolyte secondary battery comprising:
a nonaqueous electrolyte secondary battery separator recited in claim 1.

5. A nonaqueous electrolyte secondary battery member comprising:
a positive electrode;
a nonaqueous electrolyte secondary battery laminated separator recited in claim 2; and
a negative electrode,
the positive electrode, the nonaqueous electrolyte secondary battery laminated separator, and the negative electrode being arranged in this order.

6. A nonaqueous electrolyte secondary battery comprising:
a nonaqueous electrolyte secondary battery laminated separator recited in claim 2.
